(19) United States
(12) Patent Application Publication
(10) Pub. No.: US 2018/0205772 A1
(43) Pub. Date: Jul. 19, 2018

(54) FOLDER AND FILE BASED COLLABORATION USING MESSAGING

(71) Applicant: Vaultize Technologies Private Limited, Pune (IN)

(72) Inventor: Ankur Panchbudhe, Pune (IN)

(73) Assignee: Vaultize Technologies Private Limited, Pune (IN)

(21) Appl. No.: 15/918,973

(22) Filed: Mar. 12, 2018

(51) Int. Cl. H04L 29/06; H04L 12/58; G06F 17/30

(52) U.S. Cl. CPC H04L 65/4015; G06F 17/30076; H04L 63/102; H04L 51/08

(57) ABSTRACT

Disclosed herein are a method and a system for message collaboration. The system, when configured, monitors and identifies messages with attachments. Further, the system checks if all participants i.e. sender and recipients of the message have sufficient message collaboration support. If any of the recipients has no collaboration capability, or else of the message has no attachment, the message can be sent as it is. Otherwise, the system automatically converts the message to a collaboration session, and provides all participants option for viewing/editing/downloading/sharing the file/folder attachment, based on access permissions defined by sender of the message.

### TECHNICAL FIELD

The embodiments herein relate to communication networks and, more particularly, to collaboration among a plurality of users in one or more communication networks.

### BACKGROUND

Different communication networks are available to help users communicate and to help them share files over the communication network. The communication network can be a wired communication network, a wireless communication network, and so on, which enable the users to communicate with each other. For example, an email communication network allows sending and receiving of emails. Similarly, other types of messaging systems such as Instant Messaging (IM) applications also aid users in communicating. In addition to facilitating text, voice, or video based communications, these communication mediums also allows users to share data in the different file formats such as image, audio, video, or any other supported file formats as attachments. For example, a traditional email communication system allows users to send files as attachments such that the person who receives the email can download the attachment and use it. Further, most of these communication mediums can be used for personal as well as official communications.

Normally in official communications, important documents can be exchanged between team members, between different teams in an organization, and between officials of different organizations. When a message is sent with an attachment from one person to another, the sender does not have any further control over the file, which is sent as attachment. Further, the recipient of the message has to download the file to make any changes to the file. Further, in official scenarios wherein the file is sent for review to a person, the file needs to be downloaded, and after making sufficient edits and/or comment, the file must be sent back as an attachment. If there is no proper coordination between a person who drafted a report and reviewer, and if the reviewer has no clear idea as to what the person who drafted the report intends to convey, he/she can end up making unnecessary changes. This makes the whole process complicated in terms of time and work.

### BRIEF DESCRIPTION OF THE FIGURES

The embodiments herein will be better understood from the following detailed description with reference to the drawings, in which:

FIG. 1 illustrates a block diagram of a message collaboration system, as disclosed in embodiments herein;

FIG. 2 is a block diagram which depicts various components of a message client, as disclosed in the embodiments herein;

FIG. 3 is a block diagram which depicts various components of a collaboration server, as disclosed in the embodiments herein; and

FIG. 4 is a flow diagram which shows various steps involved in the process of automatically converting a message to a collaboration session, using the message collaboration system, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

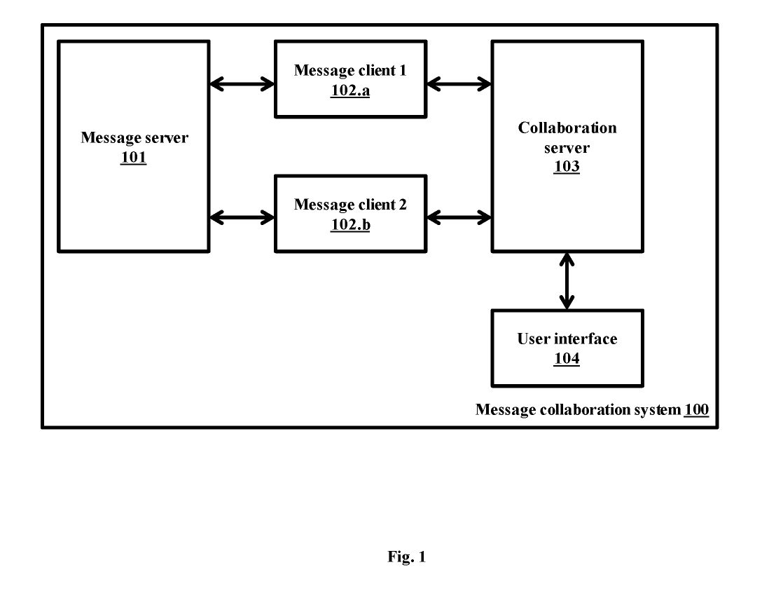

The embodiments herein disclose a mechanism for automatically converting a message to a collaboration session enabling a plurality of users to collaborate. Referring now to the drawings, and more particularly to FIGS. 1 through 4, where similar reference characters denote corresponding features consistently throughout the figures, there are shown embodiments.

FIG. 1 illustrates block diagram of a message collaboration system, as disclosed in embodiments herein. The mail message collaboration system 100 comprises a message server 101, a plurality of message clients 102, a collaboration server 103, and a user interface 104. The message server 101 can communicate with, and collect message(s) from the message clients 102. The message(s) can comprise of at least one attachment, wherein the attachment is at least one of an email, at least one attachment in an email (such as a document, an image, a media file and so on) or any other document, which can be collaborated by a plurality of users. The message server 101 can store the messages collected from the message clients 102 in an associated storage module.

The message client 102 can act as an interface between the message server 101 and the collaboration server 103. The message client 102 can communicate with the message server 101 and the collaboration server 103 to provide access for the user to the messages stored in the message server 101. In an embodiment, the message client 102 can host built-in components and means for facilitating viewing, editing, versioning access, or access to comments in the message(s).

The collaboration server 103 can communicate with the user interface 104 and the message server 101 through at least one message client 102, to facilitate the message collaboration. The collaboration server 103 can monitor and identify messages with attachment(s) and initiate message collaboration. The collaboration server 103 can perform a security check on the message and/or attachment for the presence of a threat, such as a virus, malware, spyware or any other form of threat to the participant(s). The collaboration server 103 can perform authentication to ensure that participant(s) are authorized. The collaboration server 103 can further check and ensure that all participants of a message communication support message collaboration. In an embodiment herein, the collaboration server 103 can also enable the participant(s) to perform the steps, required for enabling support of message collaboration. In an embodiment herein, the collaboration server 103 can perform steps, so as to enable the participant(s) to support message collaboration, such as downloading at least one application to the device being used by the participant(s), installing the application on the device being used by the participant(s) (with implicit or explicit permission from the user), accessing a link provided to the participant, downloading a widget, and so on. The user interface 104 can provide a suitable interface for the user to communicate with the message collaboration system 100. The user interface 104 can further provide options for the user to manage the collaboration session and for viewing and/or editing the file being collaborated, as per requirements.

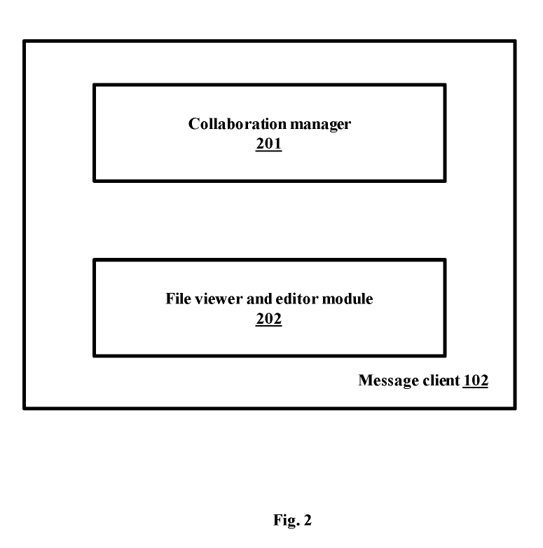

FIG. 2 is a block diagram which depicts various components of a message client, as disclosed in the embodiments herein. The message client 102 further comprises of a collaboration manager 201, and a file viewer and editor 202. The collaboration manager 201 can convert a message attachment to collaboration. The collaboration manager 201 can further convert message contents (for example, the message body) to comments on the collaboration. The collaboration manager 201 can further manage the collaboration stored on the collaboration server 103. The collaboration manager 201 can also provide means for the user to add a new file to the collaboration, and interface(s) for browsing data in the collaboration and for performing all actions supported by the collaboration session.

The file viewer and editor module 202 can provide means for at least one user to view, edit and perform any similar action on files within the message client 102. For example, other similar actions can be, but not limited to commenting on the document being collaborated, and viewing/editing the file within the message client 102. The file viewer and editor module 202 can be configured to check with the collaboration manager 201 if the user is authorized to perform the action, as being performed by the user.

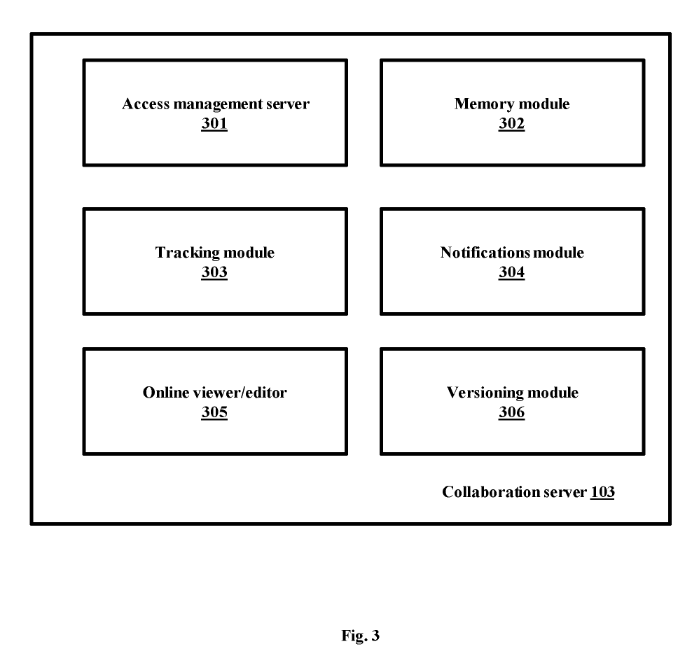

FIG. 3 is a block diagram which depicts various components of a collaboration server, as disclosed in the embodiments herein. The collaboration server 103 further comprises of an access management server 301, a memory module 302, a tracking module 303, a notifications module 304, an online viewer/editor 305, and a versioning module 306.

The access management server 301 can host at least one means for authenticating a user who is trying to access the message system with which the message collaboration system 100 is associated. The access management server 301 can further monitor file access permissions of all users, and accordingly provide/deny access for certain users, to certain files/folders. The access management server 301 can use any suitable authentication mechanism to authenticate the user, as well as file access attempts.

The memory module 302 can be used to store any data in any format, which is required for message collaboration. For example, the data used for authenticating user and file access attempts can be stored in the memory module 302. Similarly, other data collected by the collaboration server 103 as part of the message collaboration process, such as but not limited to location information, IP address, device information, network information, history of previous message collaboration sessions, and so on.

The tracking module 303 can be used for tracking location of a user request/access. The location can be tracked in terms of country, state, city, latitude, longitude, IP address, MAC address and so on. The location information can be further used by the access management module 301 to block requests from unauthorized locations, as configured by a user. The tracking module 303 can further track and log action details such as but not limited to object, time, machine details, network details, and so on. The tracking module 301 can further track IP and/or MAC address of the machine from which the user request is originated. The access management module 301 can use this information to block request(s) originated from specific pre-defined user devices (as defined by an organizer or at least one other user in the collaboration session).

The notifications module 304 can notify all people who are part of the collaboration session if any action is performed on the collaboration. The notification module 304 can provide option(s) for each participant to receive or block such notifications. Further, the notifications module 304 can support notifications of different types such as but not limited to text message, voice message, email and flash message.

The online viewer/editor 305 can enable viewing and/or editing of files through a suitable interface such as a web browser, an application window, a widget and so on. The online viewer/editor 305 can further provide means for the user to customize the view. The versioning module 306 can maintain version information of each file. The versioning module 306 can, using a suitable unique identifier associated with the file, recognize each file and maintain corresponding version details in the memory module 302 or any dedicated storage space.

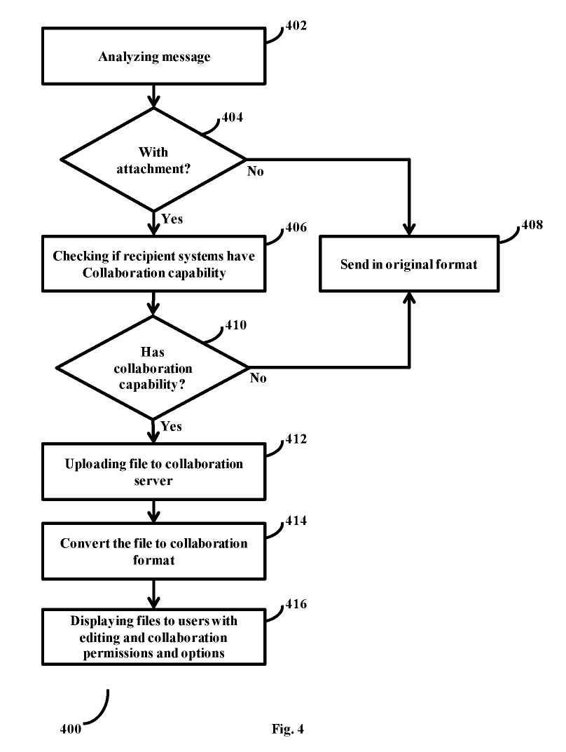

FIG. 4 is a flow diagram which shows various steps involved in the process of automatically converting a message to a collaboration session, using the message collaboration system, as disclosed in the embodiments herein. If the user intends to use message collaboration option, he/she can have to subscribe using suitable subscription means, to the message collaboration system. Further, upon subscribing to the service, certain settings and/or files that would enable the message collaboration option with the user's message system, can be downloaded and configured with the user's system. Further, the message collaboration system 100 monitors and analyzes (402) each message as and when the user creates it, and checks (404) whether the message has any file attached to it or not. The system can identify presence of an attachment in a message, based on specific identifiers. For example, a message with an attachment can be tagged with an identifier, which indicates presence of an attachment in the message. By checking presence of the identifier, the system can be able to differentiate between a message with attachment, and without attachment. Further, the message collaboration system 100 checks (406) if all or at least a required minimum number of participants support message collaboration. If the message has no attachment, or else if any of the recipients has no message collaboration capability, the message can be sent (408) in a format such as at least one of a hyperlink to the document, a link to enable the recipient to support the collaboration and so on. In another embodiment, the message collaboration system 100 can initiate message collaboration with all recipients who support message collaboration, and send the message in original format to those who do not support message collaboration. In an embodiment, the term ‘message’ can refer to message in any suitable format, as supported by the message collaboration system 100. For example, ‘message’ can be an email, an instant message (IM), or a text message.

Upon identifying that the message has a file attached to it, the collaboration manager 201 in the message client 102 checks if all participants i.e. sender and targeted recipients of the message supports message collaboration. In another embodiment, the collaboration manager 201 can initiate the message collaboration if at least a required minimum number of participants support message collaboration, such that the required minimum number of participants can vary based on requirements, and can be configured by an authorized person. If all participants are found to have sufficient hardware/software/plug-in support to use the message collaboration feature, then the collaboration manager 201 uploads (412) the file to the collaboration server 103, and a share option is created. Further, the collaboration manager 201, which can be an add-on to the message client 102, converts (414) the file to collaboration format. Converting the file to the collaboration format can also involve converting message body to comments on the collaboration, and message subject can be used as a tag for the collaboration.

The collaboration manager 201 further adds the share option to the message, and forwards the message to the recipients. The recipients, upon receiving the message, can click on the share button or link, and begin the collaboration session. In an embodiment, the share option can be displayed to only those users whose system supports the message collaboration feature. Further, the file is made accessible (416) to the user who clicks on the share button or link, with proper editing and other collaboration options. A few examples of the options provided to the user are:
List: Option to list items in collaboration
Create: To add new file/folder
Options for viewing/editing/deleting the file or folder
Option for sharing a file/folder with another user
Option to comment on the file/folder
Option to download the file/folder to local machine
Option to sync file/folder in the collaboration to local device, for offline access

In a preferred embodiment, sender of the message can be provided options for configuring access permission of each recipient to the file/folder. In an embodiment, the sender can configure same access permission for all recipients. In another embodiment, the sender of the message can configure different access permissions for different recipients. For example, one user can be given permission to share the file/folder further, while other user cannot be allowed to share the file/folder. In another embodiment, the access permissions can be defined for versions of the file/folder such that same version of different files/folders can be assigned same access permissions.

In an embodiment, any access/edit attempt by a user can automatically initiate a new message window in the same message, and notification indicating the user's action(s) can be sent to other participants. In other embodiments, the message collaboration system 100 can support different types of collaboration such as, but not limited to, Virtual Data Room (VDR), and Structured collaboration (aka Workflow). VDR refers to collaboration sessions with certain legal requirements attached to them. For example, the files shared using VDR cannot be deleted. The structured collaboration can require the collaboration to be performed in a specific order. In such cases, the message collaboration system 100 can provide suitable options for configuring required settings as well as privileges as per requirements. The various actions in method 400 can be performed in the order presented, in a different order or simultaneously. Further, in some embodiments, some actions listed in FIG. 4 can be omitted.

Now, consider one use-case scenario in which user ‘A’ is sending email to users B, C, and D. The message collaboration system 100 checks if the email contains at least one attachment. If there is no attachment, the email is sent in original format to all recipients. If there is any attachment in the email, the message collaboration system 100 checks if all or at least a minimum required recipients support message collaboration. If all or the minimum required recipients support message collaboration, then the message collaboration system 100 uploads the email and contents to the collaboration server 103, and creates a collaboration session. Further, the message collaboration system 100 shares with all recipients who support the message collaboration, a link to join and access contents of the collaboration session. Further, the users who receive the link can access the attachments, with proper editing and collaboration permissions.

The terms ‘user’, ‘recipient’ and ‘participant’ are used herein interchangeably and denote a user who is participating in the collaboration sessions, a user who desires to participate in the collaboration sessions, or a user who is intended to participate in the collaboration sessions, as disclosed herein.

The terms ‘file’ and ‘attachment’ are used herein interchangeably and denote a file which is associated with a message and can be collaborated upon by a plurality of users, as disclosed herein.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein specify a system for message collaboration. The mechanism allows automatic conversion of a message to a collaboration session, providing a system thereof. Therefore, it is understood that the scope of protection is extended to such a system and by extension, to a computer readable means having a message therein, the computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device can also include means which could be for ex. hardware means like an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment can be implemented on different hardware devices, for ex. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

We claim:

1. A method for enabling collaboration on at least one file among a plurality of users, the method comprising
fetching at least one file by a collaboration manager from a message sent by a first user to at least one other user, wherein a pre-defined number of users from the first user and the at least one other user support collaboration on at least one device used by the first user and the at least one other user;
converting the at least one file by the collaboration manager to a collaboration format; and
enabling the first user and the at least one other user to collaborate over the at least one converted file by the collaboration manager based on at least one access permission for the first user and the at least one other user for the at least one file, wherein enabling the collaboration comprises providing at least one option to the user.

2. The method, as claimed in claim 1, wherein the collaboration manager notifies the at least one user of any action performed on the file during the collaboration.

3. The method, as claimed in claim 1, wherein the method further comprises of authenticating the user by the collaboration manager, before enabling the first user and the at least one other user to collaborate over the at least one converted file.

4. The method, as claimed in claim 3, wherein authenticating the user by the collaboration manager comprises of checking if the at least one other user has access permission for the at least one file.

5. A system for enabling collaboration on at least one file among a plurality of users, the system configured for
fetching at least one file from a message sent by a first user to at least one other user, wherein and at least a pre-defined number of users from the first user and the at least one other user support collaboration on at least one device used by the first user and the at least one other user;
converting the at least one file to a collaboration format; and
enabling the first user and the at least one other user to collaborate over the at least one converted file, wherein enabling the collaboration comprises of providing at least one option to the user.

6. The system, as claimed in claim 5, wherein the system is configured for notifying the at least one user of any action performed on the collaboration.

7. The system, as claimed in claim 5, wherein the system is configured for authenticating the user, before enabling the first user and the at least one other user to collaborate over the at least one converted file.
